(19) United States
(12) Patent Application Publication
(10) Pub. No.: US 2009/0022318 A1
(43) Pub. Date: Jan. 22, 2009

(54) CONTENT DATA DISTRIBUTION TERMINAL AND CONTENT DATA DISTRIBUTION SYSTEM

(76) Inventors: Akihiro KASAHARA, Sanbu-gun (JP); Shinichi MATSUKAWA, Tokyo (JP); Hiroshi SUU, Chigasaki-shi (JP); Akira MIURA, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/175,014

(22) Filed: Jul. 17, 2008

(30) Foreign Application Priority Data
Jul. 20, 2007 (JP) 2007-190034

(51) Int. Cl. H04L 9/06

(52) U.S. Cl. 380/277

(57) ABSTRACT

A content distribution terminal includes a user key data generation unit generating new user key data representing a new version of the user key data; a user key update unit capturing, from the recordable medium, already-recorded user key data that has already been recorded on the recordable medium, and ordering the user key data generation unit to generate the new user key data when a predetermined situation is identified in the already-recorded user key data to execute an update procedure for the user key data; an erase control unit erasing, when a predetermined situation is identified in the already-recorded user key data, the first encrypted content key data that is encrypted with the already-recorded user key data and stored in the recordable medium; an encryption/decryption unit decrypting, with terminal-unique key, second encrypted content key data resulting from encryption of the content key data with different terminal-unique keys for different terminals, encrypting again content key data resulting from decryption of the second encrypted content key data with the new user key data to generate the first encrypted content key data, and encrypting the content data with the content key data to generate the encrypted content data; a write control unit writing the data to the recordable medium.

### CROSS-REFERENCE TO RELATED APPLICATIONS

This application is based upon and claims the benefit of priority from the prior Japanese Patent Application No. 2007-190034, filed on Jul. 20, 2007, the entire contents of which are incorporated herein by reference.

### BACKGROUND OF THE INVENTION

1. Field of the Invention

The present invention relates to a content distribution terminal and content distribution system for distributing encrypted content data.

2. Description of the Related Art

Recently, content data of digital information, such as music, movies or the like, is enjoyed by receiving such data via communication terminals connected to communication networks such as the Internet, in addition to terrestrial television, AM and FM broadcasting, etc.

However, since such content data of digital information can be easily copied, the relevant industry has taken some measures to encrypt the content data to be distributed with content keys. A dual-key encryption scheme is used to encrypted content data, as disclosed in, e.g., Patent Document 1 (Japanese Patent Laid-Open No. 2006-020154). In the dual-key encryption scheme, generally, a transmitting server encrypts each content data with content key data to generate encrypted content data. The server also encrypts the content key data with different user key data for different users to generate encrypted content key data. Then, the server transmits the encrypted content data and the encrypted content key data to a receiving terminal.

However, in general, user key data used in the above-mentioned system is not updated. Therefore, the user key data can be hacked and manipulated.

### SUMMARY OF THE INVENTION

One aspect of the present invention provides a content distribution terminal recording, on a recordable medium, encrypted content data resulting from encryption of content data with content key data and first encrypted content key data resulting from encryption of the content key data with user key data, comprising: a user key data generation unit generating new user key data representing a new version of the user key data; a user key update unit capturing, from the recordable medium, already-recorded user key data representing the user key data that has already been recorded on the recordable medium, and ordering the user key data generation unit to generate the new user key data when a predetermined situation is identified in the already-recorded user key data to execute an update procedure for the user key data; an erase control unit erasing, when a predetermined situation is identified in the already-recorded user key data, the first encrypted content key data that is encrypted with the already-recorded user key data and stored in the recordable medium; an encryption/decryption unit decrypting, with terminal-unique key, second encrypted content key data resulting from encryption of the content key data with different terminal-unique keys fox different terminals, encrypting again content key data resulting from decryption of the second encrypted content key data with the new user key data to generate the first encrypted content key data, and encrypting the content data with the content key data to generate the encrypted content data; and a write control unit writing the first encrypted content key data and the encrypted content data generated by the encryption/decryption unit to the recordable medium.

In addition, another aspect of the present invention provides a content distribution system having a content distribution server distributing encrypted content data resulting from encryption of content data with content key data and first encrypted content key data resulting from encryption of the content key data with user key data, and a content distribution terminal recording the encrypted content data and the first encrypted content key data on a recordable medium, wherein the content distribution terminal comprises: a user key data generation unit generating new user key data representing a new version of the user key data; a user key update unit capturing, from the recordable medium, already-recorded user key data representing the user key data that has already been recorded on the recordable medium, and ordering the user key data generation unit to generate the new user key data when a predetermined situation is identified in the already-recorded user key data to execute an update procedure for the user key data; an erase control unit erasing, when a predetermined situation is identified in the already-recorded user key data, the first encrypted content key data that is encrypted with the already-recorded user key data and stored in the recordable medium, an encryption/decryption unit decrypting, with terminal-unique key, second encrypted content key data resulting from encryption of the content key data with different terminal-unique keys for different terminals, encrypting again content key data resulting from decryption of the second encrypted content key data with the new user key data to generate the first encrypted content key data, and encrypting the content data with the content key data to generate the encrypted content data; and a write control unit writing the first encrypted content key data and the encrypted content data generated by the encryption/decryption unit to the recordable medium.

### BRIEF DESCRIPTION OF THE DRAWINGS

FIG. 1 is a schematic diagram of a content distribution system according to a first embodiment of the present invention;

FIG. 2 is a flowchart diagram illustrating the operation of the content distribution system according to the first embodiment of the present invention;

FIG. 3A is a flowchart diagram illustrating the operation of the content distribution system according to the first embodiment of the present invention;

FIG. 3B is a flowchart diagram illustrating the operation of the content distribution system according to the first embodiment of the present invention;

FIG. 4 is a schematic diagram of a content distribution system according to a second embodiment of the present invention;

FIG. 5 is a flowchart diagram illustrating the operation of the content distribution system according to the second embodiment of the present invention;

FIG. 6 is a schematic diagram of a content distribution system according to a third embodiment of the present invention;

FIG. 7 is a flowchart diagram illustrating the operation of the content distribution system according to the third embodiment of the present invention;

FIG. 8 is a flowchart diagram illustrating the operation of the content distribution system according to the third embodiment of the present invention;

FIG. 9 is a schematic diagram of a content distribution system according to a fourth embodiment of the present invention;

FIG. 10 is a schematic diagram of a content distribution system according to a fifth embodiment of the present invention, and

FIG. 11 is a diagram illustrating a typical configuration of an SD card and a user terminal, corresponding to the dual-key encryption schemes employed in the MQbic®.

### DETAILED DESCRIPTION OF THE EMBODIMENTS

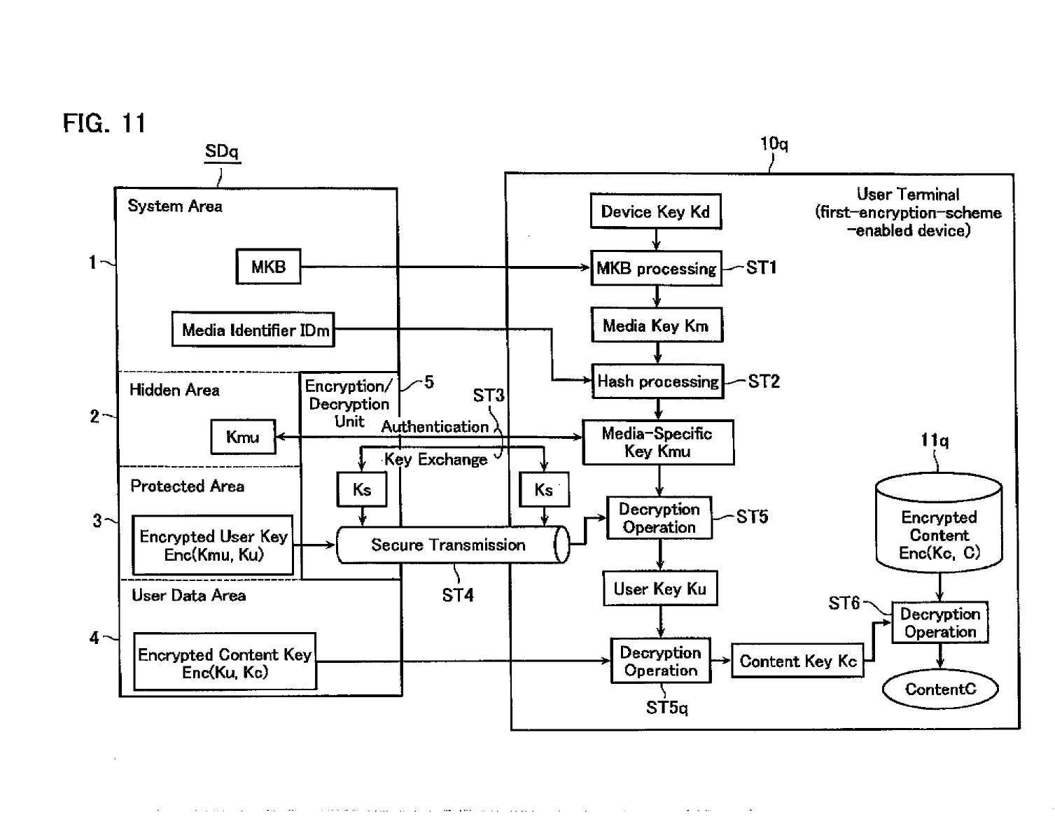

Referring first to FIG. 11, one example of the dual-key encryption schemes employed in the MQbic® will be described below. FIG. 11 is a diagram illustrating a typical configuration of an SD card and a user terminal, corresponding to such dual-key encryption schemes employed in the MQbic®. In this case, an SD card SDq is one example of secure storage media in which data is stored in a secure manner. The SD card SDq includes a System Area 1, a Hidden Area 2, a Protected Area 3, and a User Data Area 4, and an encryption/decryption unit 5. Each of these areas 1 to 4 stores data.

Specifically, in this SD card SDq, key management information MKB (Media Key Block) and media identifier IDm are stored in the System area 1, media-unique key data Kmu stored in the Hidden Area 2, encrypted user key data Enc (Kmu:Ku) stored in the Protected Area 3, and encrypted content key data Enc (Ku:Kc) stored in the User Data Area 4. Besides, in this description, information B encrypted with information A is represented as Enc (A:B). In this case, the user key data Ku is an encryption/decryption key for content key data Kc, which may be commonly used for multiple pieces of encrypted content key data Enc (Ku:Kc1), Enc (Ku:Kc2), and so on. In addition, the subscript “q” of the SD card SDq denotes that the SD card is of MQbic®-enabled type.

In this case, the System area 1 is a read-only area that is accessible to the outside world of the SD card. The Hidden Area 2 is another read-only area that is referred to by the SD card itself, but by no means accessible to the outside world. The Protected Area 3 is such an area that can be read/written from the outside world of the SD card upon a successful authentication. The User Data Area 4 is such an area that can be freely read/written from the outside world of the SD card. The encryption/decryption unit 5 provides authentication, key exchange, and Secure Transmission between the Protected Area 3 and the outside world of the SD card. The encryption/decryption unit 5 has encryption/decryption functions.

In association with the SD card SDq, a user terminal 10q for playing content logically operates as follows: The user terminal 10q performs MKB processing on the key management information MKB read from the System area 1 of the SD card SDq with the preset device key data Kd (ST1), through which media key data Km is obtained. Then, the user terminal 10q performs hash processing on the media key data Km as well as a media identifier IDm read from the System area 1 of the SD card SDq (ST2), through which media-unique key data Kmu is obtained.

Thereafter, based on the media-unique key data Kmu, the user terminal 10q performs an Authentication and Key Exchange CAKE) operation with the encryption/decryption unit 5 of the SD card SDq (ST3), through which session key data Ks is shared with the SD card SDq. Besides, the authentication and key exchange operation of step ST3 results in success when one media-unique key data Kmu in the Hidden Area 2 referred by the encryption/decryption unit 5 matches the other generated by a user terminal 10a. In this way, the session key data Ks is shared between the user terminal 10a and the SD card SDq.

Then, the user terminal 10q reads encrypted user key data Enc (Kmu:Ku) from the Protected Area 3 through Secure Transmission using the session key data Ks (ST4) and decrypts the encrypted user key data Enc (Kmu:Ku) with the media-unique key data Kmu (ST5) to obtain the user key data Ku.

Finally, a user terminal 20q reads encrypted content key data Enc (Ku:Kc) from the User Data Area 4 of the SD card SDq and decrypts the encrypted content key data Enc (Ku:Kc) with the user key data Ku (ST5q) to obtain content key data Kc. In addition, the user terminal 10a reads encrypted content data Enc (Kc:C) from a memory 11q and decrypts the encrypted content data Enc (Kc:C) with the content key data Kc (ST6) to play the obtained content data C. In this case, although the encrypted content data is stored in the memory 11q of the user terminal 20q, it may be stored in an external storage medium.

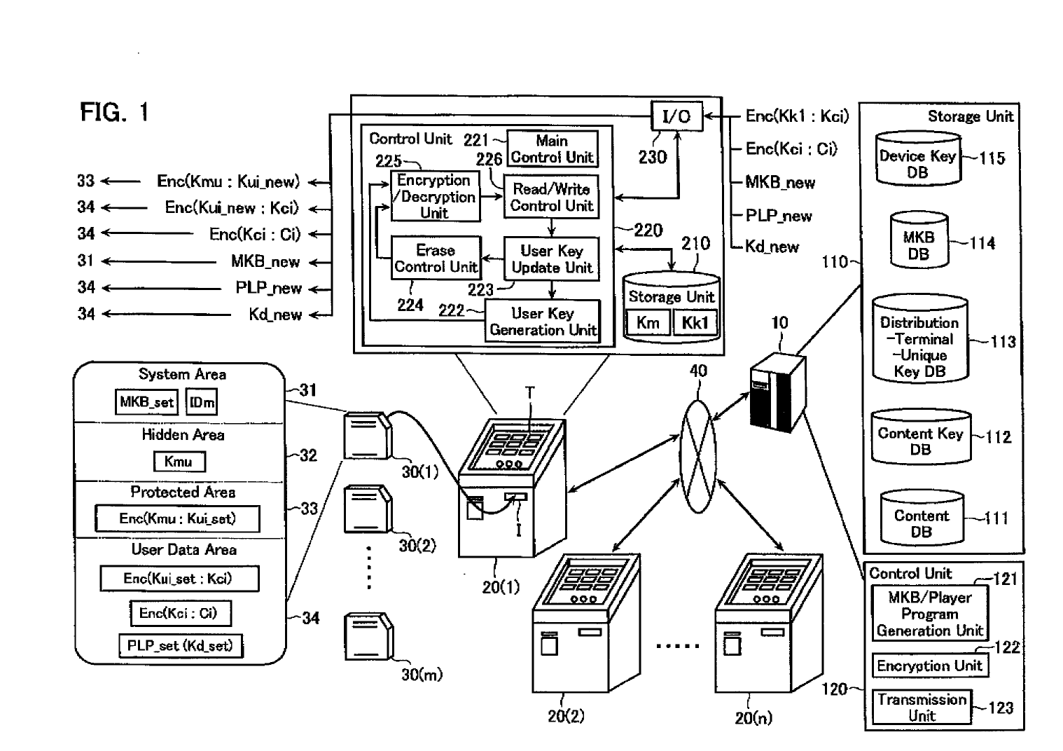

Referring now to FIGS. 1 through 10, a content distribution system according to embodiments of the present invention will be described below. Besides, the content distribution system of each embodiment uses one of the above-mentioned dual-key encryption schemes, i.e., MQbic®. The dual-key encryption scheme of this system uses encrypted content data Enc (Kci:Ci) resulting from encryption of content data Ci based on content key data Kci.

### First Embodiment

### First Embodiment Configuration

Referring now to FIG. 1, a configuration of a content distribution system according to a first embodiment of the present invention will be described below. As illustrated in FIG. 1, the content distribution system according to the first embodiment mainly comprises: a content distribution server 10 distributing content data Ci (i=1 to h); content distribution terminals 20(i) (i=1 to n) to which content data Ci, etc., is distributed from the content distribution server 10; and recording media 30(i) (i=1 to m) on which content data Ci, etc., is recorded by the content distribution terminals 20(i). The content distribution server 10 and the content distribution terminals 20(i) are connected to each other via a communication network 40 such as the Internet.

Although FIG. 1 illustrates a configuration where a single content distribution server 10 is provided, it should be noted that the present invention is not limited to that configuration. For example, multiple content servers 10 may be provided. The content distribution terminals 20(i) include, for example, those terminals positioned in Internet cafes, convenience stores, gas stations, etc., and shared among the general public. Each of the content distribution terminals 20(i) has an insertion slot I electrically connected to a recordable medium 30(i), a touch screen T, etc.

The content distribution server 10 comprises a storage unit 110 such as a HDD (Hard Disc Drive) and a control unit 120 such as a CPU (Central Processing Unit). Besides, functions of the control unit 120 are achieved by program read from the storage unit 110.

The storage unit 110 includes a content DB 111, content key DB 112, distribution-terminal-unique key DB 113, MKB DB 114, and device key DB 115. Besides, the term “DB” denotes a database. In addition, the storage unit 110 has the above-mentioned program.

The content DB 111 stores “h” pieces of plain-text content data Ci (i=1 to h).

The content key DB 112 stores content key data Kci (i=1 to h) for use in encryption of each of the h pieces of content data Ci.

The distribution-terminal-unique key DB 113 stores distribution-terminal-unique key data Kki (i1=to n) that is specific to each of the content distribution terminals 20(i).

The MKB DB 114 stores key management information MKB (Media Key Block). The key management information MKB is regularly updated in the MKB DB 114.

The device key DB 115 stores device key data Kdi (i=1 to m) that is specific to each of the recording media 30(i).

The control unit 120 has a MKB/player program generation unit 121, an encryption unit 122, and a transmission unit 123.

The MKB/player program generation unit 121 generates new key management information MKB_few (a new version of key management information MKB) on a regular basis and updates information in the MKB DB 114. In addition, the MKB/player program generation unit 121 generates new player program PLP_new (a new version of player program PLP) on a regular basis. In this case, the player program PLP is used to play content data Ci. In addition, the MKB/player program generation unit 121 generates new device key data Kd_new (a new version of device key data Kd) on a regular basis and updates information in the device key DB 115.

The encryption unit 122 encrypts content key data Kci with distribution-terminal-unique key data Kki to generate encrypted content key data Enc (Kki:Kci). In addition, the encryption unit 122 encrypts the content data Ci with the content key data Kci to generate encrypted content data En: (Kci:Ci).

The transmission unit 123 transmits the encrypted content key data Enc (Kki:Kci), the encrypted content data Enc (Kci:Ci), the new key management information MXB_new, the new player program PLP_new, the new device key data Kd_new, etc., to the content distribution terminals 20(i) via the communication network 40.

Each of the content distribution terminals 20(i) comprises a storage unit 210 such as a HDD (Hard Disc Drive), a control unit 220 such as a CPU (Central Processing Unit), and an input/output unit (I/O) 230. Besides, functions of the control unit 220 are achieved by program read from the storage unit 210.

The storage unit 210 stores in advance distribution-terminal-unique key data Kki and multiple pieces of media key information Km. For example, as illustrated in FIG. 1, a content distribution terminal 20(1) has corresponding distribution-terminal-unique key data Kk1 in the storage unit 210. In addition, the storage unit 210 has the above-mentioned program.

The control unit 220 has a main control unit 221, a user key generation unit 222, a user key update unit 223, an erase control unit 224, an encryption/decryption unit 225, and a read/write control unit 226.

The main control unit 221 controls the user key generation unit 222, user key update unit 223, erase control unit 224, encryption/decryption unit 225, read/write control unit 226 and other functions, based on the encrypted content key data Enc (Kki:Kci), encrypted content data Enc (Kci:Ci), new key management information MKB_new, new player program PLP_new, and new device key data Kd_new, respectively, each of which is input through the I/O 230. For example, as illustrated in FIG. 1, the content distribution terminal 20(1) receives encrypted content key data Enc (Kk1:Kci) that is encrypted with the corresponding distribution-terminal-unique key data Kk1.

The user key generation unit 222 generates new user key data Kui_new (i=1 to j) different for each of the recording media 30(i).

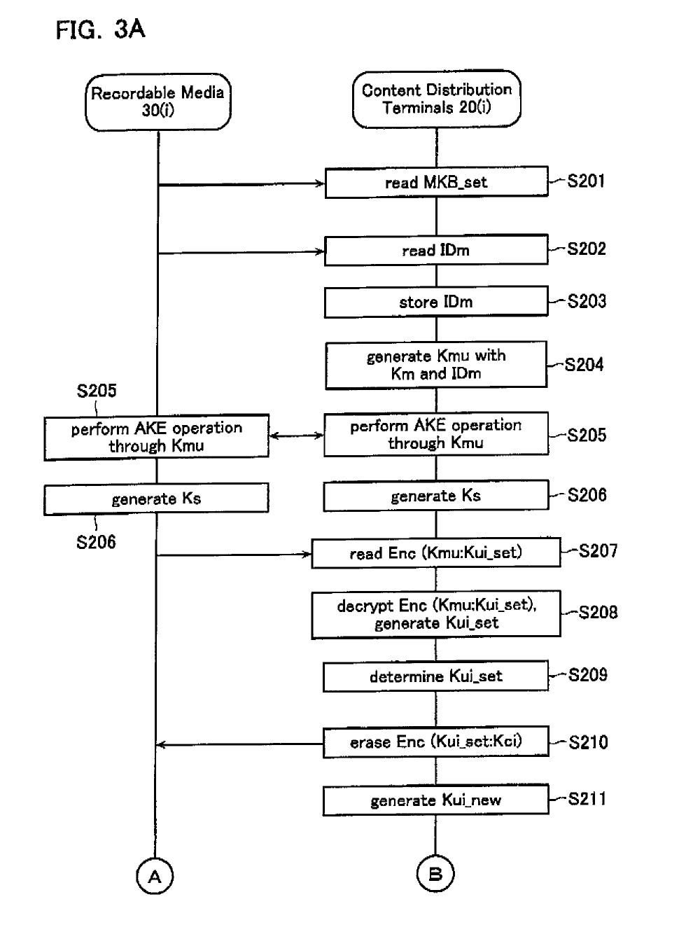

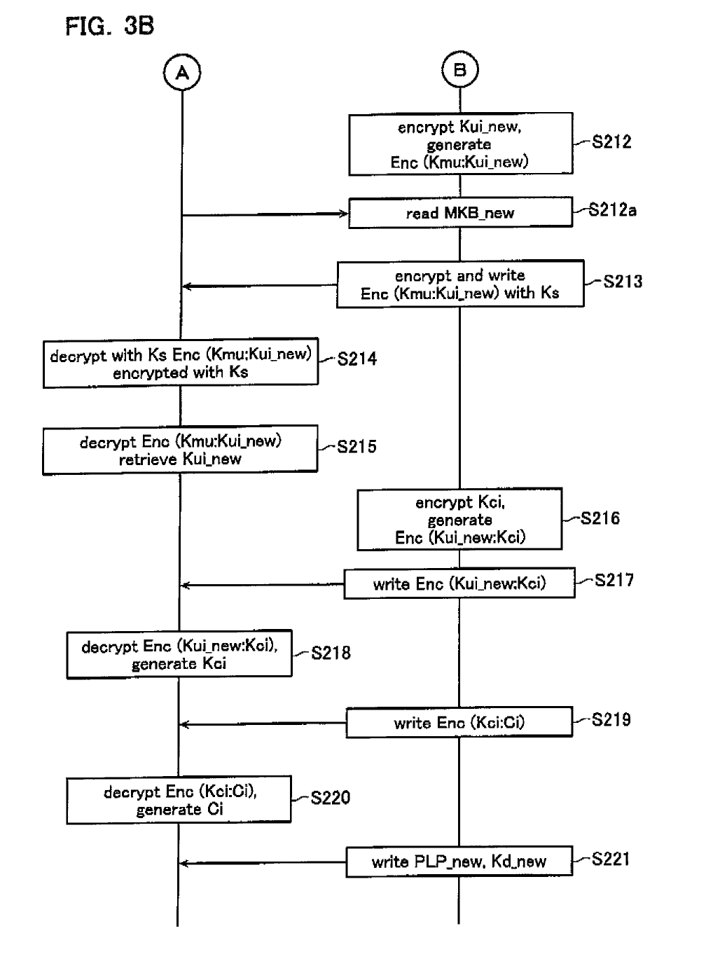

The user key update unit 223 captures user key data Kui (hereinafter, referred to as “already-recorded user key data Kui_set”) that has already been recorded on the recording media 30(i). Then, upon a predetermined situation, the user key update unit 223 orders the user key generation unit 222 to generate a new version of user key data Kui (hereinafter, referred to as “new user key data Kui_new”) to execute an update procedure for the user key data Kui. In this case, the term “predetermined situation” means such a situation where already-recorded user key data Xui set meets a preset, predetermined condition. An example of predetermined conditions is whether a predetermined period of time (e.g., six months) has elapsed since the already-recorded user key data Kui_set was recorded. Hereinafter, in FIGS. 3A and 3B, consider that the already-recorded user key data Kui_set meets the predetermined condition.

Under the control of the main control unit 221, the erase control unit 224 erases the encrypted content key data Enc (Kui_set:Kci) that is encrypted with the already-recorded user key data Kui_set and stored in the recording media 30(i) by the user key update unit 223.

The encryption/decryption unit 225 receives the encrypted content key data Enc (Kki:Kci) and the encrypted content data Enc (Kci:Ci) through the I/O 230. Under the control of the main control unit 221, the encryption/decryption unit 225 reads the distribution-terminal-unique key data Kki from the storage unit 210, decrypts the encrypted content key data Enc (Kki:Kci), and generates the content key data Kci. In addition, the encryption/decryption unit 225 encrypts the decrypted content key data Kci again with the new user key data Kui_new to generate encrypted content key data Enc (Kui_new:Kci).

The read/write control unit 226 writes the following data to the recording media 30(i): the encrypted content key data Enc (Kui_new:Kci), the encrypted content data Enc (Kci:Ci), the new key management information MKB_new, the new player program PLP_new, and the new device key data Kd_new, that are generated by the encryption/decryption unit 225.

Each of the recording media 30(i) stores program and other data. Each of the recording media 30(i) is divided into multiple areas according to different purposes. The divided areas include a System Area 31, a Hidden Area 32, a Protected Area 33, and a User Data Area 34.

The System area 31 is such an area that is accessible to the outside world of the recording media 30(i). The Hidden Area 32 is a read-only area that is referred to by the recording media 30(i), but by no means accessible to the outside world. The Protected Area 33 is such an area that can be written to/read from the outside world of the recording media 30(i) upon a successful mutual authentication. The User Data Area 34 is such an area that can be freely read/written from the outside world of the recording media 30(i).

Specifically, stored in the System Area 31 are already-recorded key management information MKB_set (already-recorded key management information MKB) and media identifier IDm. The media identifier IDm is updated each time new key management information MKB_new is stored.

In addition, stored in the Hidden Area 32 is media-unique key data Kmu and stored in the Protected Area 33 is encrypted user key data Enc (Kmu:Kui_set) that is encrypted with the media-unique key data Kmu. Further, stored in the User Data Area 34 is encrypted content key data Enc (Kui_set:Kci). Moreover, recorded in the User Data Area 34 are already-recorded device key data Kd_set (already-recorded device key data Kd), already-recorded player program PLP_set (already-recorded player program PLP), and the encrypted content data Enc (Kci:Ci).

(Operation of the First Embodiment)

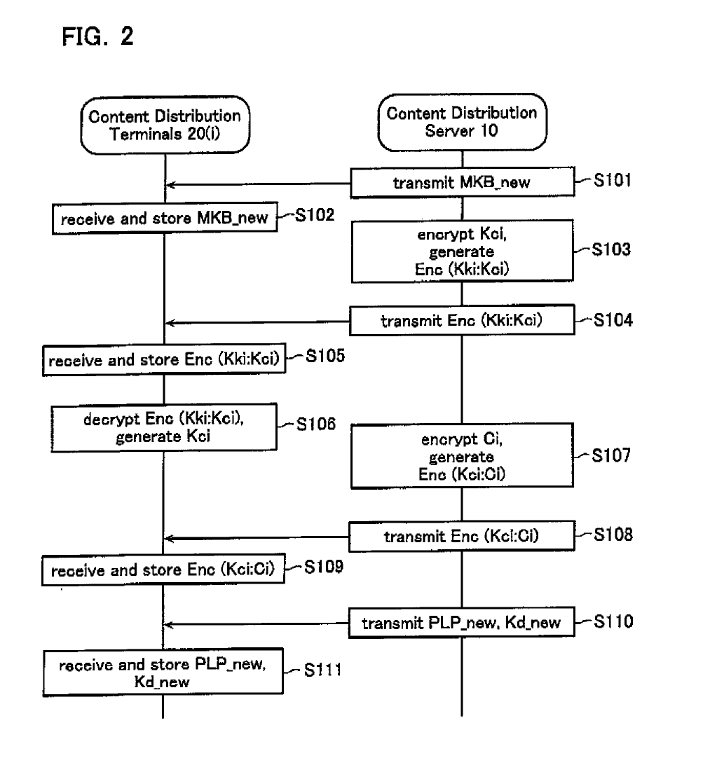

Referring now to FIG. 2, FIGS. 3A and 3B, the operation of the content distribution system according to the first embodiment will be described below. FIG. 2, FIGS. 3A and 3B are flowcharts illustrating the operation of the content distribution system according to the first embodiment.

Referring first to FIG. 2, the description is made to the distribution operation of the content data Ci, etc., from the content distribution server 10 to the content distribution terminals 20(i).

As illustrated in FIG. 2, at the content distribution server 10, the transmission unit 123 first reads new key management information MKB_new from the MKB DB 14, which is then transmitted to the content distribution terminals 20(i) (step 3101).

Following step S101, at the content distribution terminals 20(i), the I/O 230 receives the new key management information MKB_new, which is then stored in the storage unit 210 (step S102).

Following step S102, at the content distribution server 10, the encryption unit 122 encrypts content key data Kci with the distribution-terminal-unique key data Kki to generate encrypted content key data Enc (Kki:Kci) (step S103). Then, the transmission unit 123 transmits the encrypted content key data Enc (Eki:Kci) to the content distribution terminals 20(i) via the communication network 40 (step S104).

Following step S104, at the content distribution terminals 20(i), the I/O 230 receives the encrypted content key data Enc (Eki:Kci), which is then stored in the storage unit 210 (step S105). Then, the encryption/decryption unit 222 decrypts the encrypted content key data Enc (Eki:Kci) with the distribution-terminal-unique key data Kki read from the storage unit 210 to generate the content key data Kci (step S106).

Following step S106, at the content distribution server 10, the encryption unit 122 encrypts the content data Ci with the content key data Kci to generate encrypted content data Enc (Kci:Ci) (step S107). Then, the transmission unit 123 transmits the encrypted content data Enc (Kci:Ci) to the content distribution terminals 20(i) via the communication network 40 (step S108).

Following step S108, at the content distribution terminals 20(i), the I/O 230 receives the encrypted content data Enc (Kci:Ci), which is then stored in the storage unit 210 (step s109).

Following step S109, at the content distribution server 10, the transmission unit 123 transmits the new device key data Kd_new read from the device key DB 115 and the new player program PLP_new generated by the player program generation unit 121 to the content distribution terminals 20(i) via the communication network 40 (step S110).

Following step S110, at the content distribution terminals 20(i), the I/O 230 receives the new player program PLP_new and the new device key data Kd_new, each of which is then stored in the storage unit 210 (step S111).

Referring now to FIGS. 3A and 3B, the description is made to the write operation of the content data Ci, etc., from the content distribution terminals 20(i) to the recording media 30(i).

As illustrated in FIG. 3A, at the content distribution terminals 20(i), the read/write control unit 226 first reads already-recorded key management information MKB_set from the System Area 31 of the recording media 30(i) (step S201).

Then, the read/write control unit 226 reads a media identifier IDm from the System Area 31 of the recording media 30(i) (step S202) and stores the read media identifier IDm in the storage unit 210 (step S203). Then, the encryption/decryption unit 225 reads the media identifier IDm and media key information Km from the storage unit 210 to generate media-unique key data Kmu (step S204). In this case, the recording media 30(i) and the content distribution terminals 20(i) have common media-unique key data Kmu.

Following step S204, the recording media 30(i) and the encryption/decryption unit 222 of each of the content distribution terminals 20(i) perform an AKE (Authentication and Key Exchange) operation through the common media-unique key data Kmu (step S205). Then, through the AKE operation of step S205, the recording media 30(i) and the encryption/decryption unit 225 of the content distribution terminals 20(i) generate common session key data Ks (step S206).

Following step S206, at the content distribution terminals 20(i), the read/write control unit 226 reads the encrypted user key data Enc (Kmu:Kui_set) from the Protected Area 33 of the recording media 30(i) (step S207), which is then decrypted to generate already-recorded user key data Kui_set (step S208). Then, the user key update unit 223 determines whether the already-recorded user key data Kui_set meets the predetermined condition (step S209).

Then, if it is determined by the user key update unit 223 in step S209 that the already-recorded user key data Kui_set meets the predetermined condition, then the erase control unit 224 erases the encrypted content key data Enc (Kui_set:Kc) from the User Data Area 34 of the recording media 30(i) (step S210). Then, the user key update unit 223 orders the user key generation unit 222 to generate new user key data Kui_new. Consequently, the user key generation unit 222 generates new user key data Kui_new (step S211).

Then, as illustrated in FIG. 3B, the encryption/decryption unit 225 encrypts the new user key data Kui_new with the media-unique key data Kmu to generate encrypted user key data Enc (Kmu:Kui_new) (step S212). Then, the read/write control unit 226 reads the new key management information MKB_new from the storage unit 210, which is then written to the System Area 31 of the recording media 30(i) (step S212a). In this case, corresponding to the new key management information MKB_new, the media identifiers IDm are updated in the recording media 30(i). Then, after the encrypted user key data Enc (Kmu:Kui_new) is encrypted with the session key data Ks at the encryption/decryption unit 225, the read/write control unit 226 writes the encrypted user key data Enc (Kmu:Kui_new) encrypted with the session key data Ks to the Protected Area 33 of the recording media 30(i) (step S213). Besides, as in step S213, the operation of steps S205 and S206 is performed each time data is written to the Protected Area 33 of the recording media 30(i).

Following step S213, the recording media 30(i) decrypts, with the session key data Ks, the encrypted user key data Enc (Kmu:Kui_new) encrypted with the session key data Ks that is written at step S212 (step S214). Then, the recording media 30(i) decrypts the encrypted user key data Enc (Kmu:Kui_new) with the media-unique key data Kmu to retrieve new user key data Kui_new (step S215).

Following step S215, at the content distribution terminals 20(i), the read/write control unit 226 reads content key data Kci from the storage unit 210, encrypts the read content key data KCi with the new user key data Kui_new, and generates encrypted content key data Enc (Kui_new:Kci) (step S216). Then, the read/write control unit 226 writes the encrypted content key data Enc (Kui_new:Kci) generated at step S215 to the User Data Area 34 of the recording media 30(i) (step S217).

Following step S217, the recording media 30(i) decrypts the encrypted content key data Enc (Kui_new:Kci) that is written at step S217 with the new user key data Kui_new to generate the content key data Kci (step S218).

Following step S218, at the content distribution terminals 20(i), the read/write control unit 226 reads the encrypted content data Enc (Kci:Ci) from the storage unit 210, which is then written to the User Data Area 34 of the recording media 30(i) (step S219).

Following step S219, the recording media 30(i) decrypts the encrypted content data Enc (Kci:Ci) that is written at step S219 with the content key data Kci to generate the content data Ci (step S220).

Following step S220, at the content distribution terminals 20(i), the read/write control unit 226 reads the new player program PLP_new from the storage unit 210, which is then written to the User Data Area 34 of the recording media 30(i) (step S221). Thereafter, the operation of the content distribution system according to the first embodiment terminates.

As can be seen from the above, the content distribution system according to the first embodiment and the content distribution terminals 20(i) allow new user key data Kui_new to be generated and written to the recording media 30(i) when the already-recorded user key data Kui_set meets a predetermined condition. Thus, since the user key data Kui is updated as needed, even if user key data Kui is hacked, it is possible to prevent the encrypted data from being decrypted with the hacked user key data Kui after updating. This means that the security of the system may be increased.

In addition, the content distribution system according to the first embodiment and the content distribution terminals 20(i) allow new key management information MKB_new to be generated and written to the recording media 30(i). Thus, since key management information MKB is updated as needed, even if the key management information MKB is hacked, it is possible to prevent the encrypted data from being decrypted with the hacked key management information MKB after updating. This means that the security of the system may be further increased.

### Second Embodiment

### Second Embodiment Configuration

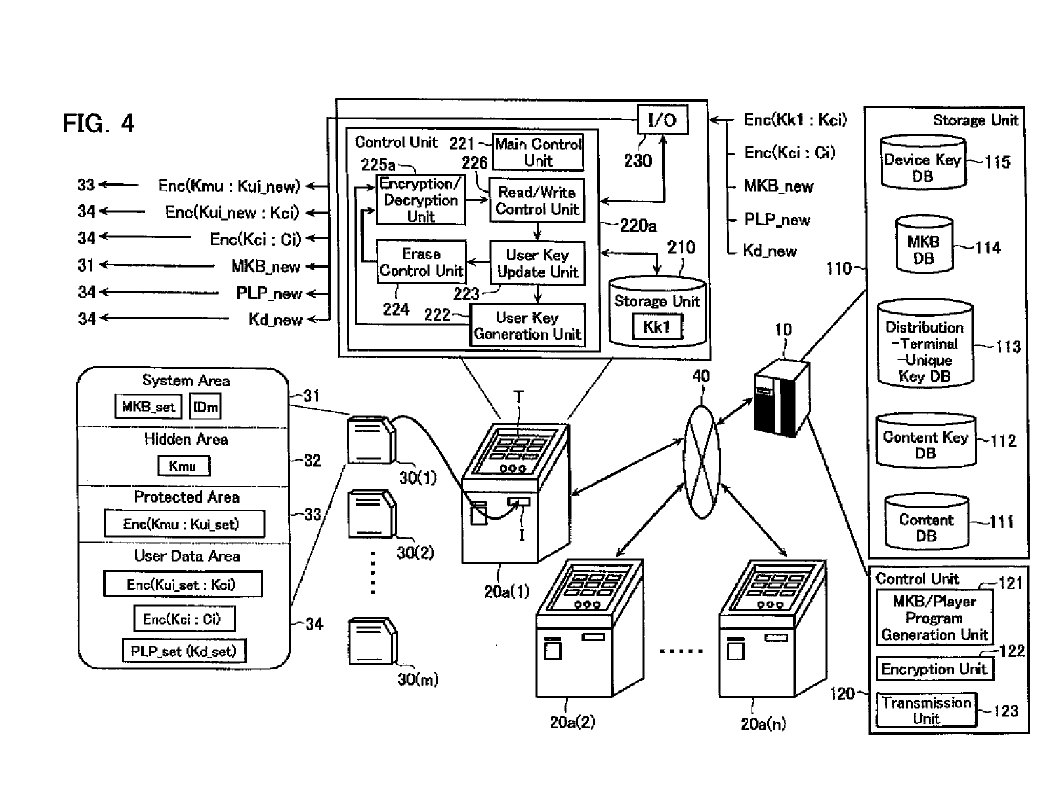

Referring now to FIG. 4, a content distribution system according to a second embodiment will be described below. FIG. 4 is a schematic diagram of the content distribution system according to the second embodiment. As illustrated in FIG. 4, the content distribution system according to the second embodiment includes content distribution terminals 20a(i), each with a different configuration than that of the content distribution terminals 20(i) according to the first embodiment. The content distribution system of the second embodiment is different from the first embodiment in performing MKB processing with device key data Kd. Besides, in the second embodiment, the same reference numerals refer to the same components as the first embodiment and description thereof will be omitted.

Each of the content distribution terminals 20a(i) has a control unit 220a different from the first embodiment. The control unit 220a has an encryption/decryption unit 225a with encryption/decryption functions different from the first embodiment. In addition, the storage unit 210 stores in advance only distribution-terminal-unique key data Kki, i.e., it does not store media key information Km as the first embodiment.

(Operation of the Second Embodiment)

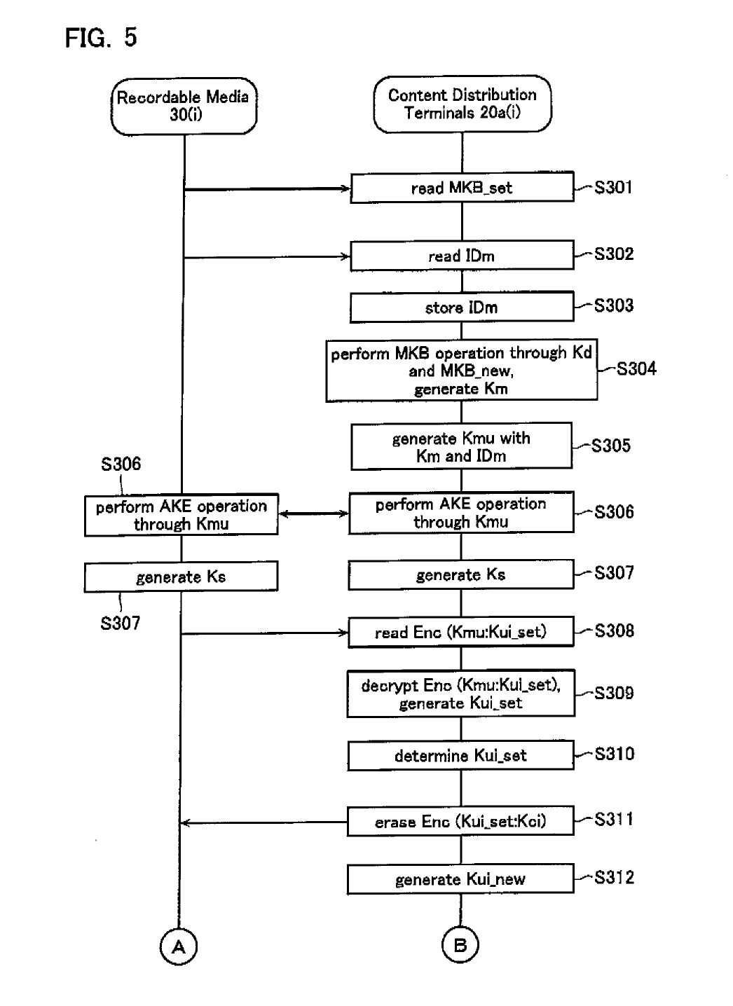

Referring now to FIG. 5, the description is made to the write operation of the content data Ci, etc., from the content distribution terminals 20a(i) to the recording media 30(i) according to the second embodiment. FIG. 5 is a flowchart illustrating the operation of the content distribution system according to the first embodiment. Besides, in the second embodiment, the distribution operation of the content data Ci, etc., from the content distribution server 10 to the content distribution terminals 20a(i) is the same as the first embodiment illustrated in FIG. 2 and description thereof will be omitted.

As illustrated in FIG. 5, operation of steps S301 through S303 is first performed at the content distribution terminals 20a(i). Besides, the operation of steps S301 through S303 is similar to that described in conjunction with steps S201 through S203 of the first embodiment and description thereof will be omitted. Following step S303, at the content distribution terminals 20a(i), the encryption/decryption unit 225a performs MKB processing using device key data Kd and key management information MKB to generate media key information Km (step S304). Then, the content distribution terminals 20a (i) and the recording media 30(i) perform operation of steps S305 through S311. Besides, the operation of steps S305 through S312 is similar to that described in conjunction with steps S204 through S211 of the first embodiment and description thereof will be omitted. In addition, after step S312, operation is performed that is similar to the operation of steps S212 through S221 of the first embodiment.

As can be seen from the above, the content distribution system according to the second embodiment and the content distribution terminals 20a(i) provide the same advantages as the first embodiment.

### Third Embodiment

### Third Embodiment Configuration

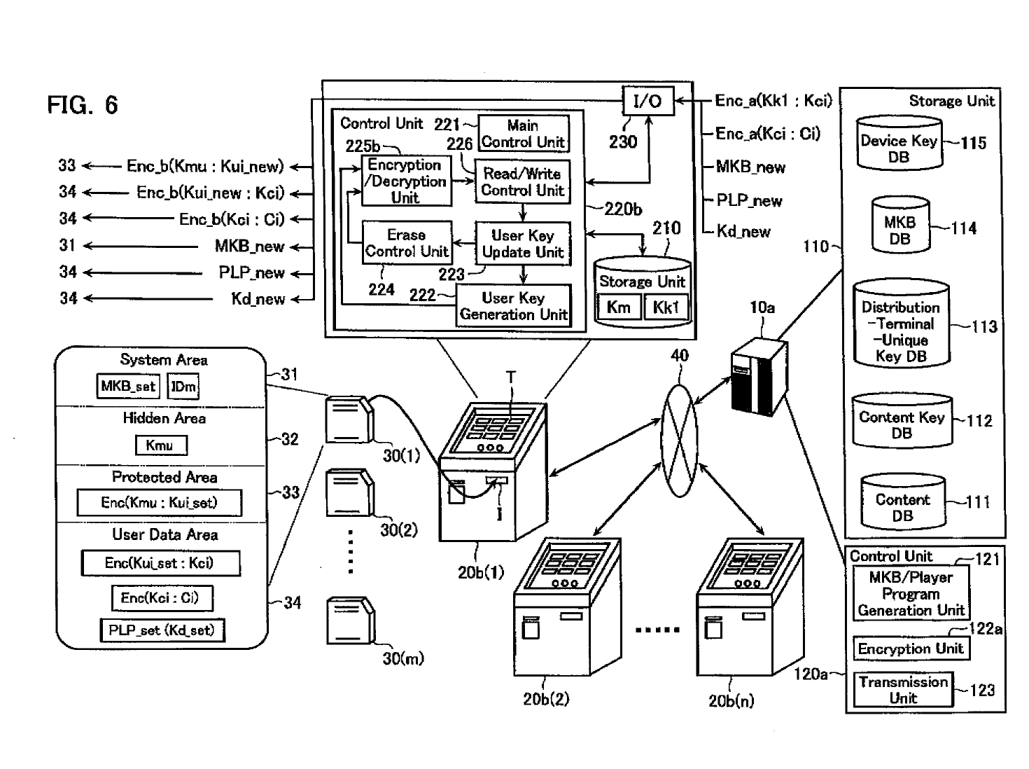

Referring now to FIG. 6, a content distribution system according to a third embodiment will be described below. FIG. 6 is a schematic diagram of the content distribution system according to the third embodiment. As illustrated in FIG. 6, the content distribution system according to the third embodiment includes a content distribution server 10a and content distribution terminals 20b(i), each with a different configuration than that of the first and second embodiments, respectively. The content distribution system according to the third embodiment uses an encryption scheme for the content distribution server 10a and the content distribution terminals 20b(i) and another different encryption scheme for the content distribution terminals 20b(i) and the recording media 30(i) to distribute and write content data Ci, etc. Besides, in the third embodiment, the same reference numerals refer to the same components as the first and second embodiments and description thereof will be omitted.

The content distribution server 10a has a control unit 120a different from the first and second embodiments. The control unit 120a has an encryption unit 122a with encryption functions different from the first and second embodiments. Each of the content distribution terminals 20b(i) has a control unit 220b different from the first and second embodiments. The control unit 220b has an encryption/decryption unit 225b with encryption/decryption functions different from the first and second embodiments.

(Operation of the Third Embodiment)

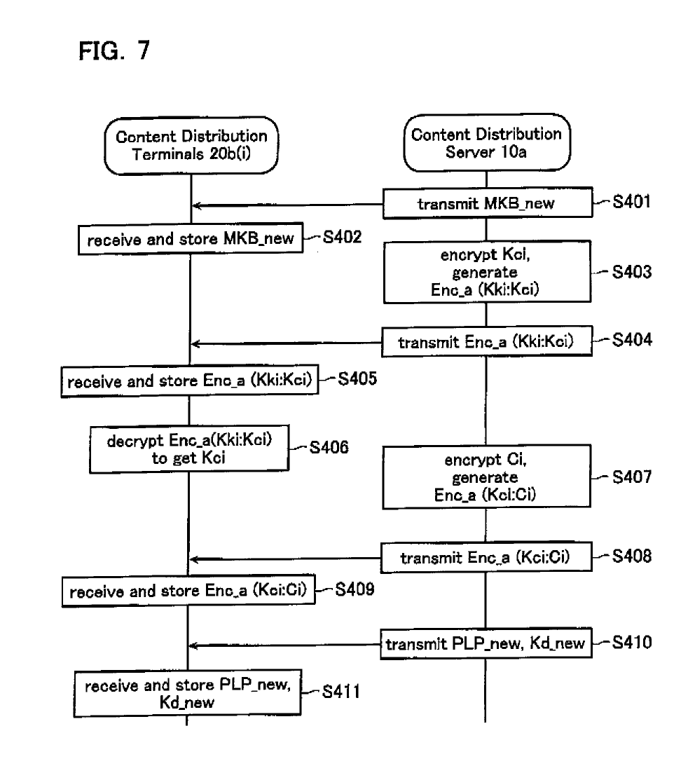

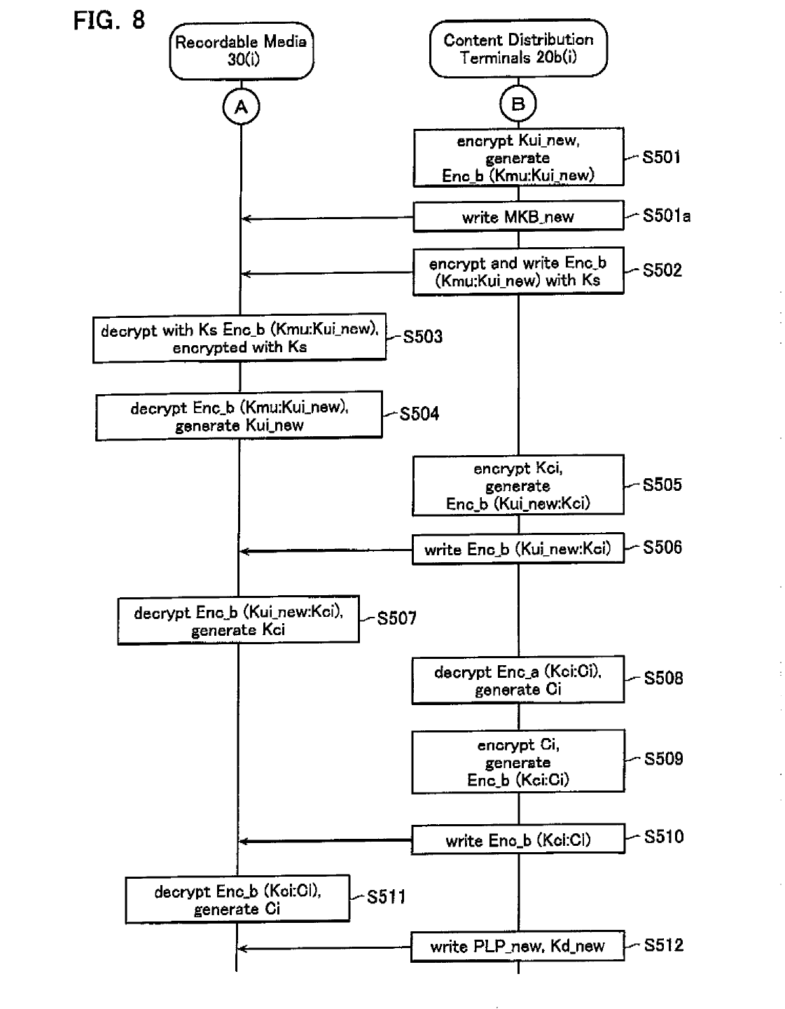

Referring now to FIGS. 7 and 8, the operation of the content distribution system according to the third embodiment will be described below. FIGS. 7 and 8 are flowcharts illustrating the operation of the content distribution system according to the third embodiment.

Referring first to FIG. 7, the description is made to the distribution operation of the content data Ci, etc., from the content distribution server 10 to the content distribution terminals 20b(i).

As illustrated in FIG. 7, the content distribution server 10a and the content distribution terminals 20b(i) first perform operation of steps S401 and S402 that is similar to the operation of steps S101 and S102 of the first embodiment.

Following step S402, at the content distribution server 10a, the encryption unit 122a encrypts content key data Kci with distribution-terminal-unique key data Kki based on a first scheme to generate first-scheme-encrypted content key data Enc_a (Kki:Kci) (step S403). In this case, the first scheme is, e.g., the AES (Advanced Encryption Standard). Then, the transmission unit 123 transmits the first-scheme-encrypted content key data Enc_a (Kki:Kci) to the content distribution terminals 20b(i) (step S404).

Following step S404, at the content distribution terminals 20b(i), the I/O 230 receives the first-scheme-encrypted content key data Enc_a (Kki:Kci), which is then stored in the storage unit 210 (step S405). Then, the encryption/decryption unit 225b decrypts the first-scheme-encrypted content key data Enc_a (Kki:Kci) with the distribution-terminal-unique key data Kki to get the content key data Kci (step S406).

Following step S406, at the content distribution server 1a, the encryption unit 122a encrypts the content data Ci with the content key data Kci based on the first scheme to generate first-scheme-encrypted content data Enc_a (Kci:Ci) (step S407). Then, the transmission unit 123 transmits the first-scheme-encrypted content data Enc_a (Kci:Ci) to the content distribution terminals 20b(i) (step S408).

Following step S408, at the content distribution terminals 20b(i), the I/O 230 receives the first-scheme-encrypted content data Enc_a (Kci:Ci), which is then stored in the storage unit 210 (step S409).

Then, the content distribution server 10a and the content distribution terminals 20b(i) perform steps S410 and S411 that are similar to steps S110 and S111 of the first embodiment.

Referring now to FIG. 8, the description is made to the write operation of the content data Ci, etc., from the content distribution terminals 20b(i) to the recording media 30(i). In the write operation according to the third embodiment, such operation is first performed, similar to that described in conjunction with steps S201 through S211 of the first embodiment. Then, after the operation of step S211, the operation of steps S501 through S512 is performed that is different from the first embodiment.

Following step S211, at the content distribution terminals 20b(i), the encryption/decryption unit 225b first encrypts new user key data Kui_new with media-unique key data Kmu based on a second scheme to generate second-scheme-encrypted user key data Enc_b (Kmu:Kui_new) (step S501). In this case, the second scheme is, e.g., the C2 encryption scheme. Then, the read/write control unit 226 reads new key management information MKB_new from the storage unit 210, which is then written to the System Area 31 of the recording media 30(i) (step S501a). Then, after the second-scheme-encrypted user key data Enc_b (Kmu:Kui_new) is encrypted with the session key data Ks at the encryption/decryption unit 225b, the read/write control unit 226 writes the second-scheme-encrypted user key data Enc_b (Kmu:Kui_new) encrypted with the session key data Ks to the Protected Area 33 of the recording media 30(i) (step S502).

Following step S502, the recording media 30(i) decrypts, with the session key data Ks, the second-scheme-encrypted user key data Enc_b (Kmu:Kui_new) encrypted with the session key data Ks that is written at step S502 (step S503). Then, the recording media 30(i) decrypts the second-scheme-encrypted user key data Enc_b (Kmu:Kui_new) with the media-unique key data Kmu to generate the new user key data Kui_new (step S504).

Following step S504, at the content distribution terminals 20b(i), the read/write control unit 226 reads content key data Kci from the storage unit 210 and encrypts the read content key data Kci with the new user key data Kui_new based on the second scheme to generate second-scheme-encrypted content key data Enc_b (Kui_new:Kci) (step S505). Then, the read/write control unit 226 writes the second-scheme-encrypted content key data Enc_b (Kui_new:Kci) generated at step S505 to the User Data Area 34 of the recording media 30(i) (step S506).

Following step S506, the recording media 30(i) decrypts the second-scheme-encrypted content key data Enc_b (Kui_new_Kci) written at step S506 with the new user key data Kui_new to generate the content key data Kci (step S507).

Following step S507, at the content distribution terminals 20b(i), the encryption/decryption unit 225b reads the first-scheme-encrypted content data Enc_a (Kci:Ci) from the storage unit 210, which is then decrypted with the content key data Kci to generate the content data Ci (step S508). Then, the encryption/decryption unit 225b encrypts the generated content data Ci with the content key data Kci based on the second scheme to generate second-scheme-encrypted content data Enc_b (Kci:Ci) (step S509). Then, the read/write control unit 226 writes the generated second-scheme-encrypted content data Enc_b (Kci:Ci) to the User Data Area 34 of the recording media 30(i) (step S510).

Following step S510, the recording media 30(i) decrypts the second-scheme-encrypted content data Enc_b (Kci:Ci) written at step S510 with the content key data Kci to generate the content data Ci (step S511).

Then, at the content distribution terminals 20b(i), the read/write control unit 226 performs operation of step S512 that is similar to the operation of step S221 in the first embodiment. Thereafter, the operation of the content distribution system according to the third embodiment terminates.

As can be seen from the above, the content distribution system according to the third embodiment and the content distribution terminals 20b(i) provide the same advantages as the first embodiment.

### Fourth Embodiment

### Fourth Embodiment Configuration

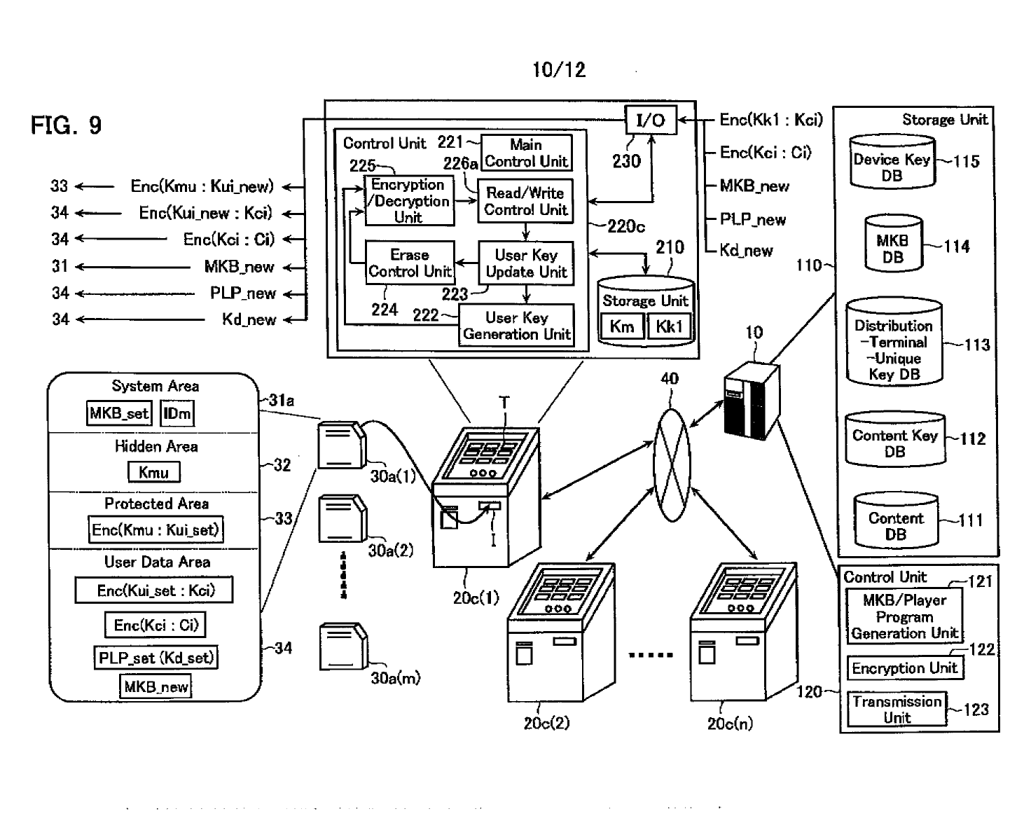

Referring now to FIG. 9, a content distribution system according to a fourth embodiment will be described below. FIG. 9 is a schematic diagram of a content distribution system according to a fourth embodiment. As illustrated in FIG. 9, the content distribution system according to the fourth embodiment includes content distribution terminals 20c(i) and recording media 30a(i), each with a different configuration than that of the content distribution terminals 20(i) and the recording media 30(i) according to the first embodiment, respectively. Besides, in the fourth embodiment, the same reference numerals refer to the same components as the first embodiment and description thereof will be omitted.

Each of the content distribution terminals 20c(i) has a control unit 220c different from the first embodiment. The control unit 220c has a read/write control unit 226a with writing functions different from the first embodiment. The read/write control unit 226a writes new key management information MKB_new to the User Data Area 34 of the recording media 30a(i).

Each of the recording media 30a(i) has a read-only System Area 31a different from the first embodiment.

The read/write control unit 226a has a function for combining already-recorded key management information MKB_set stored in the System Area 31 of each of the recording media 30a (i) with new key management information MKB_new stored in the User Data Area 34 thereof to read the combined information as one piece of key management information MKB. Besides, except the above-mentioned write and read operations, the operation of the fourth embodiment is the same as the first embodiment and description thereof will be omitted.

As can be seen from the above, the content distribution system according to the fourth embodiment and the content distribution terminals 20c(i) provide the same advantages as the first embodiment.

### Fifth Embodiment

### Fifth Embodiment Configuration

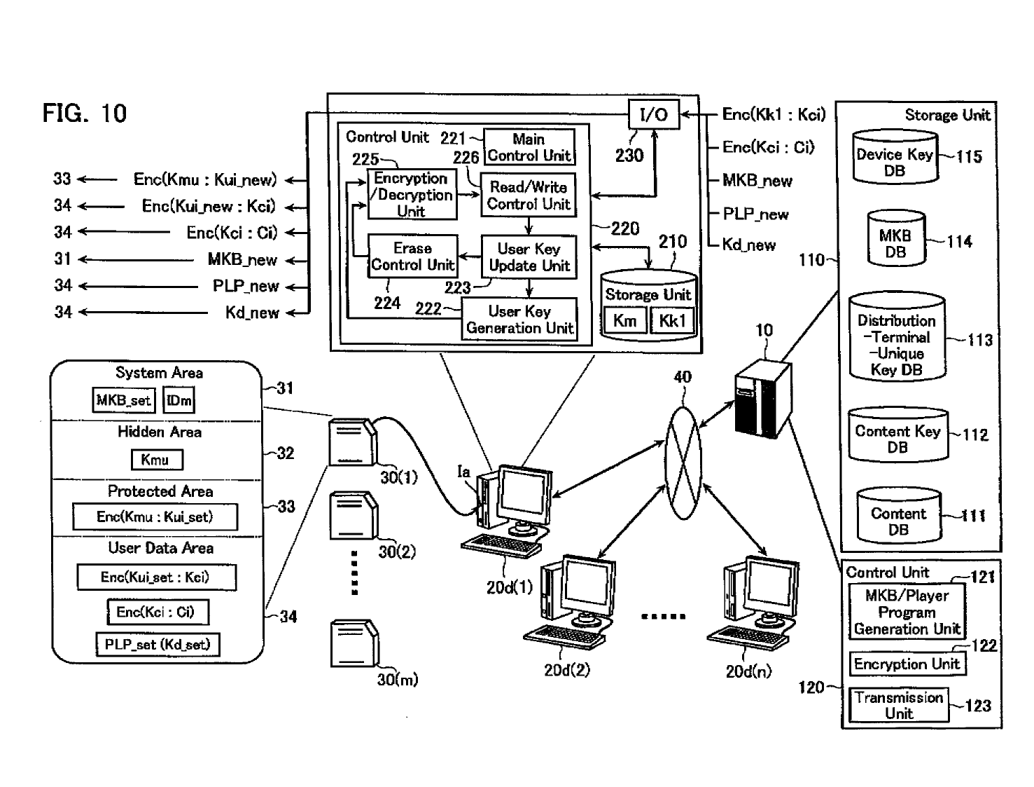

Referring now to FIG. 10, a content distribution system according to a fifth embodiment will be described below. FIG. 10 is a schematic diagram of a content distribution system according to a fifth embodiment. As illustrated in FIG. 10, the content distribution system according to the fifth embodiment includes content distribution terminals 20d(i), each with a different configuration than that of the content distribution terminals 20(i) to 20c(i) according to the first through fourth embodiments, respectively. Besides, in the fifth embodiment, the same reference numerals refer to the same components as the first embodiment and description thereof will be omitted.

The content distribution terminals 20d(i) according to the fifth embodiment include personal computers that are personally or domestically managed, rather than terminals that are shared among the general public. Each of the content distribution terminals 20d(i) has an insertion slot Ia electrically connected to a recordable medium 30(i). Besides, the content distribution terminals may be mobile phones, etc., not limited to the configuration of the fifth embodiment.

Although embodiments of the present invention have been described, the present invention is not intended to be limited to the disclosed embodiments and various other changes, additions, replacements or the like may be made thereto without departing from the spirit of the invention. Although the above-mentioned embodiments have been described to have a configuration using those dual-key encryption schemes employed in the MQbic®, other schemes may also be used.

In addition, new key management information MKB_new, new player program PLP_new, and new device key data Kd_new may be transmitted and written at a time other than those described in the disclosed embodiments. Further, those steps of transmitting and writing new key management information MKB_new, new player program PLP_new, and new device key data Kd_new may be omitted, if not required.

What is claimed is:

1. A content distribution terminal recording, on a recordable medium, encrypted content data resulting from encryption of content data with content key data and first encrypted content key data resulting from encryption of the content key data with user key data, comprising:
a user key data generation unit generating new user key data representing a new version of the user key data;
a user key update unit capturing, from the recordable medium, already-recorded user key data representing the user key data that has already been recorded on the recordable medium, and ordering the user key data generation unit to generate the new user key data when a predetermined situation is identified in the already-recorded user key data to execute an update procedure for the user key data;
an erase control unit erasing, when a predetermined situation is identified in the already-recorded user key data, the first encrypted content key data that is encrypted with the already-recorded user key data and stored in the recordable medium;
an encryption/decryption unit decrypting, with terminal-unique key, second encrypted content key data resulting from encryption of the content key data with different terminal-unique keys for different terminals, encrypting again content key data resulting from decryption of the second encrypted content key data with the new user key data to generate the first encrypted content key data, and encrypting the content data with the content key data to generate the encrypted content data; and
a write control unit writing the first encrypted content key data and the encrypted content data generated by the encryption/decryption unit to the recordable medium.

2. The terminal according to claim 1, further comprising:
a key management information generation unit generating new key management information representing a new version of key management information, wherein
the write control unit writes the new key management information to the recordable medium.

3. The terminal according to claim 2, wherein
the write control unit writes the new key management information to a system area of the recordable medium.

4. The terminal according to claim 2, further comprising;
a read control unit reading, as one piece of information, the key management information stored in the system area of the recordable medium and the key management information stored in a user data area of the recordable medium, wherein
the write control unit writes the new key management information to the user data area of the recordable medium.

5. The terminal according to claim 1, further comprising:
a playing program generation unit generating new playing program representing playing program that newly plays the content data, wherein
the write control unit writes the new playing program to the recordable medium.

6. The terminal according to claim 1, wherein
the encryption/decryption unit performs the following operations:
decrypting first-scheme second encrypted content key data with the terminal-unique key, the first-scheme second encrypted content key data representing the second encrypted content key data that is encrypted based on a first scheme; encrypting the decrypted content key data again with the new user key data based on a second scheme to generate second-scheme first encrypted content key data; and encrypting the content data with the content key data based on the second scheme to generate second-scheme encrypted content data.

7. A content distribution system having a content distribution server distributing encrypted content data resulting from encryption of content data with content key data and first encrypted content key data resulting from encryption of the content key data with user key data, and a content distribution terminal recording the encrypted content data and the first encrypted content key data on a recordable medium, wherein
the content distribution terminal comprises:
a user key data generation unit generating new user key data representing a new version of the user key data;
a user key update unit capturing, from the recordable medium, already-recorded user key data representing the user key data that has already been recorded on the recordable medium, and ordering the user key data generation unit to generate the new user key data when a predetermined situation is identified in the already-recorded user key data to execute an update procedure for the user key data;
an erase control unit erasing, when a predetermined situation is identified in the already-recorded user key data, the first encrypted content key data that is encrypted with the already-recorded user key data and stored in the recordable medium;
an encryption/decryption unit decrypting, with terminal-unique key, second encrypted content key data resulting from encryption of the content key data with different terminal-unique keys for different terminals, encrypting again content key data resulting from decryption of the second encrypted content key data with the new user key data to generate the first encrypted content key data, and encrypting the content data with the content key data to generate the encrypted content data; and
a write control unit writing the first encrypted content key data and the encrypted content data generated by the encryption/decryption unit to the recordable medium.

8. The system according to claim 7, wherein
the content distribution terminal comprises a key management information generation unit generating new key management information representing a new version of key management information, and
the write control unit writes the new key management information to the recordable medium.

9. The system according to claim 8, wherein
the write control unit writes the new key management information to a system area of the recordable medium.

10. The system according to claim 8, wherein
the content distribution terminal comprises a read control unit reading, as one piece of information, the key management information stored in the system area of the recordable medium and the key management information stored in a user data area of the recordable medium, and
the write control unit writes the new key management information to the user data area of the recordable medium.

11. The system according to claim 7, wherein
the content distribution terminal comprises a playing program generation unit generating new playing program representing playing program that newly plays the content data, and
the write control unit writes the new playing program to the recordable medium.

12. The system according to claim 7, wherein
the encryption/decryption unit performs the following operations:
decrypting first-scheme second encrypted content key data with the terminal-unique key, the first-scheme second encrypted content key data representing the second encrypted content key data that is encrypted based on a first scheme; encrypting the decrypted content key data again with the new user key data based on a second scheme to generate second-scheme first encrypted content key data; and encrypting the content data with the content key data based on the second scheme to generate second-scheme encrypted content data.
